(19) United States
(12) Patent Application Publication
(10) Pub. No.: US 2014/0234646 A1
(43) Pub. Date: Aug. 21, 2014

(54) Polymerizable Composition, Polymerized Composition, Article, And Method Of Making The Same

(71) Applicant: 3M INNOVATIVE PROPERTIES COMPANY, St. Paul, MN (US)

(72) Inventors: Appuswamy Devasenapathi, Singapore (SG); Brant U. Kolb, Afton, MN (US)

(21) Appl. No.: 14/346,919

(22) PCT Filed: Sep. 25, 2012
(86) PCT No.: PCT/US2012/057069

§ 371 Date: Mar. 24, 2014

Related U.S. Application Data
(60) Provisional application No. 61/539,663, filed on Sep. 27, 2011.

(51) Int. Cl. C09D 133/14

(52) U.S. Cl. CPC C09D 133/14; C08K 2201/001; C08K 2201/00; C08K 3/28
USPC 428/520; 524/853; 524/558; 427/385.5; 427/380

(57) ABSTRACT

A polymerizable composition includes: from 10x to 50x moles of at least one hydroxy-functional (meth)acrylate ester having a hydroxyl group; from 0. 1x to 25x moles of at least one metal nitrate compound, wherein the at least one metal nitrate compound comprises at least one metal selected from the group consisting of Al, Ti, V, Cr, Mn, Fe, Co, Ni, Cu, Zn, Ga, Ge, Mo, Pd, Ag, Cd, Sn, Sb, Te, Pt, Au, Pb, Bi, and combinations thereof; and from 0.001x to 0.0035x moles of at least one organic compound having a sterically hindered aminooxyl group, wherein x is a positive number. A polymerized composition, article including the polymerized composition, and method of making the article are also disclosed.

### FIELD

The present disclosure broadly relates to polymerizable and polymerized compositions, methods of making them, and articles including them.

### BACKGROUND

Polymerizable compositions and their corresponding polymerized compositions are useful in fields such as, for example, protective coatings and/or antistatic coatings.

In the electronic industry, protective coatings are used to protect wires and circuit components, and antistatic coatings are used in chip carrier tubes, electrostatic dischargeable carrier bags and cover tapes for component carriers to circumvent the losses incurred due to static charge build-up. The typical surface resistivity requirements of such antistatic coatings are in the range of 10⁷-10¹¹ ohms/square. In addition, optical transparency, and stability to high relative humidity and temperature changes during transportation and usage are also desirable features for many applications.

### SUMMARY

In one aspect, the present disclosure provides a polymerizable composition comprising:
from 10x to 50x moles of at least one hydroxy-functional (meth)acrylate ester having a hydroxyl group, wherein x is a positive number;
from 0. 1x to 25x moles of at least one metal nitrate compound, wherein the at least one metal nitrate compound comprises at least one metal selected from the group consisting of Al, Ti, V, Cr, Mn, Fe, Co, Ni, Cu, Zn, Ga, Ge, Mo, Pd, Ag, Cd, Sn, Sb, Te, Pt, Au, Pb, Bi, and combinations thereof; and
from 0.001x to 0.0035x moles of at least one organic compound having a sterically hindered aminooxyl group.

In another aspect, the present disclosure provides a polymerized composition made by at least partially polymerizing the at least one hydroxy-functional (meth)acrylate ester having a hydroxyl group of a polymerizable composition according to the present disclosure.

In another aspect, the present disclosure provides an article comprising a substrate, and a layer comprising a polymerized composition according to the present disclosure disposed on a surface of the substrate.

In another aspect, the present disclosure provides a method of making an article, the method comprising:

disposing a layer of a polymerizable composition according to the present disclosure onto a substrate; and
at least partially polymerizing the at least one hydroxy-functional (meth)acrylate ester having a hydroxyl group.

In some embodiments, the at least one organic compound having a sterically hindered aminooxyl group comprises a compound represented by the formula:

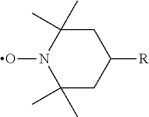

wherein R represents H, amino, acetamido, carboxyl, cyano, benzoyloxy, hydroxyl, phenyl, and alkyl having from 1 to 6 carbon atoms. In the instance wherein R is H the molecule is known in the chemical arts as TEMPO.

As used herein:

the phrase “Nx” wherein N is a positive number means N multiplied by x;

the term “aminooxyl” refers to a radical consisting of a nitrogen atom that is singly bonded to each of two carbon atoms and one oxygen atom (e.g., as in TEMPO above);

the term “colorless” as applied to layers and coatings means that color is not visibly discernible by a human observer with 20/20 vision;

the term “(meth)acryl” refers to acryl and/or methacryl; and

the term “solvent” refers to organic solvents only.

The features and advantages of the present disclosure will be further understood upon consideration of the detailed description as well as the appended claims.

### BRIEF DESCRIPTION OF THE DRAWINGS

FIG. 1 is a cross-sectional side view of an exemplary article according to the present disclosure.

### DETAILED DESCRIPTION

Polymerizable compositions according to the present disclosure include a reactive component and optionally a non-free-radically-polymerizable solvent.

The reactive component comprises at least one hydroxy-functional (meth)acrylate ester, at least one metal nitrate compound, and at least one organic compound having a sterically hindered aminooxyl group.

Useful hydroxy-functional (meth)acrylate esters include, for example, 2-hydroxyethyl (meth)acrylate, 2-hydroxypropyl (meth)acrylate, 3-hydroxypropyl (meth)acrylate, 4-hydroxybutyl (meth)acrylate, 2-hydroxy-1-methylethyl (meth)acrylate, 2-hydroxy-3-phenoxypropyl (meth)acrylate, 2-hydroxy-1-phenylethyl (meth)acrylate, HO(CH₂)₅C(═O)O(CH₂)₅C(═O)OCH₂CH₂OC(═O)CH═CH₂ (e.g., as available as SR495B CAPROLACTONE ACRYLATE from Sartomer USA, LLC, Exton, Pa.), HO(CH₂)₅C(═O)O(CH₂)₅C(═O)OCH₂CH₂C(═O)C(CH₃)═CH₂, and combinations thereof. Of these, 2-hydroxyethyl methacrylate and 2-hydroxyethyl acrylate are preferred. Useful monomers can be obtained from commercial suppliers such as, for example, Sartomer USA, LLC, and UCB Radcure, Smyrna, Ga.

If desired, one or more other free-radically polymerizable monomers may be included in addition to the hydroxy-functional (meth)acrylate ester(s), preferably in an amount of less than 30 percent, less than 20 percent, less than 10 percent, or even less than 5 percent. Examples of such free-radically polymerizable monomers include acrylamide, polyethylene glycol mono- or di-acrylates, 1,6-hexanediol diacrylate, tripropylene glycol diacrylate, trimethylolpropane triacrylate, and pentaerythritol tetraacrylate. In some preferred embodiments, the polymerizable composition is essentially free of (i.e., contains less than one weight percent) of free-radically polymerizable compounds other than hydroxy-functional (meth)acrylate esters.

Useful metal nitrate compounds include nitrates of aluminum, titanium, vanadium, chromium, manganese, iron, cobalt, nickel, copper, zinc, gallium, germanium, molybdenum, palladium, silver, cadmium, tin, antimony, tellurium, platinum, gold, lead, bismuth, and combinations thereof (e.g., either as a mixture of metal nitrate salts or as mixed metal nitrate salts). Of these nitrates of zinc, silver, nickel, and copper are preferred. Zinc nitrate is particularly useful for application in which transparency and low color are important considerations. The metal nitrate compound(s) may be in an anhydrous or a hydrated form. In some embodiments, polymerizable compositions are essentially free of, or even free of, metal compounds other than metal nitrate compounds. The metal nitrate compound can serve multiple functions. For example, it can serve as a thermal initiator for free-radical polymerization, it forms polymer crosslinks (e.g., to form a gel if a solvent is present) via hydroxyl groups of the polymerized composition, and it imparts a degree of conductivity to the polymerized composition which is useful in applications where antistatic properties are desired.

Useful organic compounds having a sterically hindered aminooxyl group include, for example, 2,2,5,5-tetramethyl-3-pyrrolineoxyl (PROXYL) and its derivatives and 2,2,6,6-tetramethylpiperidine-1-oxyl (TEMPO) and its derivatives. For example, in preferred embodiments, the organic compound having a sterically hindered aminooxyl group may be represented by the formula:

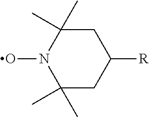

wherein R represents a group selected from H, hydroxyl, acetamido, alkoxy having from 1 to 6 carbon atoms (e.g., methoxy, ethoxy, propoxy, butoxy, pentoxy, or hexoxy), carboxyl, cyano, benzoyloxy, hydroxyl, (meth)acryloyloxy, phenyl, and alkyl having from 1 to 6 carbon atoms (e.g., methyl, ethyl, propyl, butyl, pentyl, or hexyl). 4-oxo-TEMPO may also be used. Preferably, the organic compound having a sterically hindered aminooxyl group comprises 4-hydroxy-TEMPO.

While TEMPO and its derivatives, and similar compounds with sterically hindered aminooxyl groups, are known as polymerization inhibitors, the present inventors have unexpectedly found that in certain circumstances (e.g., in certain relative amounts, and/or in the presence of metal nitrate salts) they may act as a promoter for the polymerization of acrylic monomers. While not required, one or more non-free-radically-polymerizable alcoholic solvents are preferably included in the polymerizable composition to improve solubility of its components (e.g., metal nitrate compound(s)) and/or to adjust viscosity (e.g., to facilitate coating on a substrate). If present, the amount of non-free-radically polymerizable alcoholic solvent preferably comprises from 10 to 70 percent by weight, preferably from 20 to 40 percent by weight, of the total weight of the polymerizable composition. Non-free-radically-polymerizable alcoholic solvents preferably having a low enough normal boiling point (e.g., preferably less than 150° C.) to evaporate after coating. Examples of suitable non-free-radically-polymerizable alcoholic solvents include 1-methoxy-2-propanol, 2-methoxyethanol, methanol, ethanol, isopropanol, n-propanol, and n-butanol.

Non-hydroxyl-group-containing organic solvents (e.g., tetrahydrofuran or dimethylformamide) and/or water may be included in the polymerizable composition. The polymerizable composition may include optional additives such as, for example, fillers, fragrances, surfactants, chain transfer agents, flow modifiers, colorants, and UV stabilizers.

The reactive component of the polymerizable composition includes in relative proportion: from 10x to 50x moles (preferably from 15x to 25x moles) of the at least one hydroxy-functional (meth)acrylate ester; from 0.1x to 25x moles (preferably from x to 8x moles) of the at least one metal nitrate compound; and from 0.001x to 0.0035x moles of the at least one organic compound having a sterically hindered aminooxyl group. In some embodiments, the amount of the at least one organic compound having a sterically hindered aminooxyl group is in a range of from 0.001x to 0.0033x moles. With regard to the above amounts, the number x represents any positive number (i.e., a real number greater than zero such as, e.g., 0.001, 0.5, 7, or 25).

The polymerizable composition may be polymerized thermally; for example, by heating to a sufficient temperature (e.g., 80° C.-120° C., although higher and lower temperature may also be used). In some cases, it may be desirable to include one or more additional conventional thermal initiators to facilitate polymerization.

The polymerizable composition may be polymerized photochemically; for example, by exposure to actinic radiation. In some cases, it is generally desirable to include one or more photoinitiators (e.g., a Type-I and/or Type-II photoinitiator). Such photoinitiators are well-known to those of ordinary skill in the art and include acylphosphines, benzophenone and its derivatives, benzoin ethers, and acyloin ethers.

Polymerization, whether complete or partial, of the polymerizable composition results in a polymerized composition. The polymerized composition may be diluted (e.g., with water and /or solvent), or concentrated (e.g., by evaporation) to obtain an appropriate viscosity for coating on a substrate. Alternatively, the polymerizable composition may be coated onto a substrate and polymerized as a coating. Any suitable coating method may be used. Examples include, dip coating, brushing, spraying, roll coating, ink jet printing, screen printing, gravure coating, curtain coating, bar coating, and knife coating. After coating, drying and/or subsequent curing steps are generally desirable in order to obtain optimal mechanical film properties.

Methods according to the present disclosure may be carried out as batch or continuous processes. For example, coating onto substrates and any subsequent optional curing may be carried out using a roll to roll configuration.

In general, the thickness of the dried and/or cured coating of the polymerized composition, and its metal content influence the surface conductivity of the coating, and hence its antistatic properties. Typically, coatings formed from polymerizable compositions according to the present disclosure may be formulated to achieve a surface resistivity in a range of from 10⁷ to 10¹¹ ohms/square. Coating layer thickness may range, for example, from 0.1 microns to 150 microns, or more, but are preferably in a range of from 0.5 to 10 microns. Other coating thicknesses may also be used.

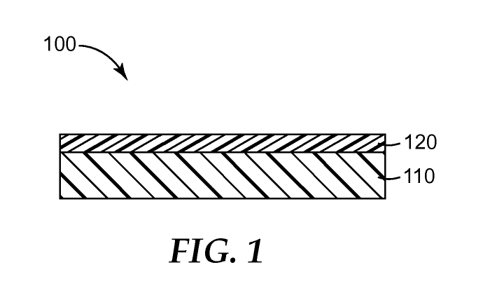

FIG. 1 shows an exemplary article 100 according to the present disclosure, which comprises substrate 110, which has layer 120 disposed thereon. Layer 120 comprises a polymerized composition according to the present disclosure. Exemplary substrates may comprise organic polymeric material, glass, and/or ceramic. Exemplary substrates may comprise sheets, films, tubes, or tapes. Exemplary articles include cover tapes for chip carriers, static protection bags, and chip carrier tubes. Coatings comprising polymerized compositions according to the present disclosure may advantageously provide both antistatic properties and abrasion resistance in such applications, where current technologies have resorted to use of two separate layers (e.g., an aluminum layer and an epoxy layer).

### SELECT EMBODIMENTS OF THE PRESENT DISCLOSURE

In a first embodiment, the present disclosure provides a polymerizable composition comprising:
from 10x to 50x moles of at least one hydroxy-functional (meth)acrylate ester having a hydroxyl group, wherein x is a positive number;
from 0. 1x to 25x moles of at least one metal nitrate compound, wherein the at least one metal nitrate compound comprises at least one metal selected from the group consisting of Al, Ti, V, Cr, Mn, Fe, Co, Ni, Cu, Zn, Ga, Ge, Mo, Pd, Ag, Cd, Sn, Sb, Te, Pt, Au, Pb, Bi, and combinations thereof; and
from 0.001x to 0.0035x moles of at least one organic compound having a sterically hindered aminooxyl group.

In a second embodiment, the present disclosure provides a polymerizable composition according to the first embodiment, wherein the reactive component comprises from 15x to 25x moles of the at least one hydroxy-functional (meth)acrylate ester having a hydroxyl group.

In a third embodiment, the present disclosure provides a polymerizable composition according to the first or second embodiment, wherein the at least one hydroxy-functional (meth)acrylate ester having a hydroxyl group comprises a (meth)acrylate ester selected from the group consisting of 2-hydroxyethyl (meth)acrylate, 2-hydroxypropyl (meth)acrylate, 3-hydroxypropyl (meth)acrylate, 4-hydroxybutyl (meth)acrylate, HO(CH₂)₅C(═O)O(CH₂)₅C(═O)OCH₂CH₂C(═O)CH═CH₂, HO(CH₂)₅C(═O)O(CH₂)₅C(═O)OCH₂CH₂C(═O)C(CH₃)═CH₂, (2-hydroxy-1-methylethyl) (meth)acrylate, 2-hydroxy-3-phenoxypropyl (meth)acrylate, (2-hydroxy-1-phenylethyl) (meth)acrylate, and combinations thereof.

In a fourth embodiment, the present disclosure provides a polymerizable composition according to any of the first to third embodiments, further comprising at least one non-free-radically-polymerizable solvent.

In a fifth embodiment, the present disclosure provides a polymerizable composition according to any of the first to fourth embodiments, wherein the at least one hydroxy-functional (meth)acrylate ester having a hydroxyl group comprises 2-hydroxyethyl methacrylate.

In a sixth embodiment, the present disclosure provides a polymerizable composition according to any of the first to fifth embodiments, wherein the reactive component comprises from x to 8x moles of the at least one metal nitrate compound.

In a seventh embodiment, the present disclosure provides a polymerizable composition according to any of the first to sixth embodiments, wherein the at least one metal nitrate consists essentially of zinc nitrate.

In an eighth embodiment, the present disclosure provides a polymerizable composition according to any of the first to seventh embodiments, wherein the at least one organic compound having a sterically hindered aminooxyl group comprises TEMPO or a substituted derivative thereof.

In a ninth embodiment, the present disclosure provides a polymerizable composition according to any of the first to eighth embodiments, wherein the at least one organic compound having a sterically hindered aminooxyl group comprises a compound represented by the formula:

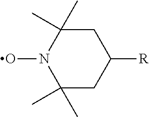

wherein R represents H, amino, acetamido, carboxyl, cyano, benzoyloxy, hydroxyl, phenyl, and alkyl having from 1 to 6 carbon atoms.

In a tenth embodiment, the present disclosure provides a a polymerized composition made by at least partially polymerizing the at least one hydroxy-functional (meth)acrylate ester having a hydroxyl group in the polymerizable composition according to any of the first to tenth embodiments.

In an eleventh embodiment, the present disclosure provides an article comprising a substrate, and a layer comprising a polymerized composition according to the tenth embodiment disposed on a surface of the substrate.

In a twelfth embodiment, the present disclosure provides an article according to the eleventh embodiment, wherein the layer has a surface resistivity of less than or equal to 10¹⁰ ohms/square.

In a thirteenth embodiment, the present disclosure provides an article according to the eleventh embodiment, wherein the layer has a surface resistivity of less than or equal to 10⁸ ohms/square.

In a fourteenth embodiment, the present disclosure provides an article according to any of the eleventh to thirteenth embodiments, wherein the layer is colorless and transparent.

In a fifteenth embodiment, the present disclosure provides a method of making an article, the method comprising:
disposing a layer of the polymerizable composition according to the first embodiment onto a substrate; and
at least partially polymerizing the at least one hydroxy-functional (meth)acrylate ester having a hydroxyl group.

In a sixteenth embodiment, the present disclosure provides a method according to the fifteenth embodiment, further comprising heating the layer to cause polymerization.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. In the examples, the abbreviation “mM” refers to millimoles.

### Materials Used in the Examples

Zinc nitrate hexahydrate, 2-hydroxyethyl methacrylate (hereinafter “HEMA”), 2-hydroxy-3-phenoxypropyl acrylate (hereinafter “HPPA”), isobornyl acrylate, methyl methacrylate, 2-(N,N-dimethylamino)ethyl acrylate, ethylene glycol dimethacrylate, 2-methoxy-1-propanol (hereinafter “MPOH”), and 4-hydroxy-TEMPO (i.e., 4-Hydroxy-2,2,6,6-tetramethylpiperidin-1-oxyl) were obtained from Sigma-Aldrich Chemical Co., Saint Louis, Missouri. Dipentaerythritol pentaacrylate (available as SR 399) and ethoxylated (4) bisphenol A diacrylate (available as SR 601B) were obtained from Sartomer USA, LLC.

### Method of Making Coating Compositions

One-pot synthesis of polymerized compositions was carried out by the reaction of zinc nitrate hexahydrate, HEMA, and 4-hydroxy-TEMPO dissolved in MPOH at 80° C. Initial screening reactions were carried out in 20 mL glass bottles, and confirmatory reactions were carried out in 250 mL round-bottom flasks. The reaction progress was monitored at 5 minute intervals. By the time the reaction mixture turned into a highly viscous sol (before it solidified into a hard gel), the reaction was terminated and the time to form the viscous sol was taken as the time for the completion of the reaction. After polymerization, the resultant viscous sol was diluted to 50 percent by weight with MPOH to form a coating solution.

### Coating Application Method

Solutions of polymerized compositions, diluted to 50 percent by weight with MPOH (or with methanol if specifically indicated), were coated on polyester substrates using wire wound Meyer rods (obtained from R. D. Specialties, Webster, N.Y.) as indicated. Rod numbers 2 (nominal wet thickness=4.57 microns), 3 (nominal wet thickness=6.86 microns), 4 (nominal wet thickness=9.14 microns), 5 (nominal wet thickness=11.43 microns), and 6 (nominal wet thickness=13.72 microns) were used. The coatings were thermally cured at 100° C. (or 120° C. if specifically indicated) for 1 hour. The coatings on polyester obtained after thermal curing were optically clear.

### Surface Resistivity Measurement

Surface resistivity was measured using a HIRESTA-UP MCP-HT450 (Mitsubishi Chemical Corporation, Tokyo, Japan) surface resistivity meter equipped with a 4 pin probe, and using an applied voltage of 10V. Ten surface resistivity measurements were taken randomly over an area of 20 cm×30 cm.

### CROSS HATCH ADHESION TEST

The adhesion of the coatings to polyester substrates was tested generally according to ASTM test method D3359-09 “STANDARD TEST METHODS FOR MEASURING ADHESION BY TAPE TEST”. Cross hatch lines were made using a pen knife on the coatings at 2 mm intervals and SCOTCH PREMIUM CELLOPHANE TAPE 610 pressure-sensitive tape (3M Company, St. Paul, Minn.) was applied on it. The tape was pulled rapidly, and the coating was observed for any peel off due to the pulling. The extent of peel in the coating was used to judge the adhesion of the coatings.

### Haze Measurement

Haze measurements on the coatings were carried out using a TOYOSEIKI—HAZE GARD II haze meter (Toyoseiki Seisaku-sho Ltd., Tokyo, Japan).

### Examples 1 to 12

Polymerized compositions were prepared and formulated into coating solutions according to the METHOD OF MAKING COATING COMPOSITIONS using the amounts of components shown in Table 1 (below).

TABLE 1

| | POLYMERIZABLE COMPOSITION | | | | |
|---|---|---|---|---|---|
| | ZINC | | | | TIME TO |
| | NITRATE | | | | FORM |
| | HEXA- | | | | VISCOUS |
| | HYDRATE, | TEMPO, | HEMA, | MPOH, | SOL |
| EXAMPLE | mM | mM | mM | mM | hours |
| 1 | 0.34 | 0.00109 | 38 | 22 | 166 |
| 2 | 0.85 | 0.00109 | 38 | 22 | 14 |
| 3 | 1.7 | 0.00109 | 38 | 22 | 1.2 |
| 4 | 2.55 | 0.00109 | 38 | 22 | 0.5 |
| 5 | 3.4 | 0.00109 | 38 | 22 | 0.45 |
| 6 | 4.25 | 0.00109 | 38 | 22 | 0.4 |
| 7 | 5 | 0.00109 | 38 | 22 | 0.4 |
| 8 | 5.95 | 0.00109 | 38 | 22 | 0.4 |
| 9 | 6.7 | 0.00109 | 38 | 22 | 0.4 |
| 10 | 8.4 | 0.00109 | 38 | 22 | 1.2 |
| 11 | 10.1 | 0.00109 | 38 | 22 | 1.8 |
| 12 | 13.5 | 0.00109 | 38 | 22 | 3.2 |

### Examples 13-37

Surface resistivity values of the coatings obtained with reaction mixtures having different Zn(NO₃)₂ concentrations and coating thicknesses are reported in Table 2. The reaction mixture was obtained with changes in zinc nitrate concentrations as listed in Table 2 (below) and with the HEMA (38 mM), 4-Hydroxy-TEMPO (0.00109 mM) and MPOH (22 mM) concentrations held at constant levels.

TABLE 2

| | | ZINC NITRATE | COATING |
|---|---|---|---|
| | COATING | HEXAHYDRATE | SURFACE |
| | THICKNESS, | CONTENT, | RESISTIVITY, |
| EXAMPLE | microns | mM | 10⁸ ohm/square |
| 13 | 1 | 1.68 | 860-41000 |
| 14 | 1 | 3.36 | 180-6100 |
| 15 | 1 | 5.05 | 8.40-190 |
| 16 | 1 | 6.73 | 2.10-56.0 |
| 17 | 1 | 8.41 | 4.60-47.0 |
| 18 | 2 | 1.68 | 160-6200 |
| 19 | 2 | 3.36 | 160-7000 |
| 20 | 2 | 5.05 | 5.40-110 |
| 21 | 2 | 6.73 | 2.50-62.0 |
| 22 | 2 | 8.41 | 1.10-25.0 |
| 23 | 3 | 1.68 | 210-4700 |
| 24 | 3 | 3.36 | 90.0-850 |
| 25 | 3 | 5.05 | 11.0-110 |
| 26 | 3 | 6.73 | 1.40-410 |
| 27 | 3 | 8.41 | 0.80-22.0 |
| 28 | 4 | 1.68 | 350-4900 |
| 29 | 4 | 3.36 | 20.0-420 |
| 30 | 4 | 5.05 | 7.80-21.0 |
| 31 | 4 | 6.73 | 1.90-39.0 |
| 32 | 4 | 8.41 | 1.80-23.0 |
| 33 | 5 | 1.68 | 90.0-850 |
| 34 | 5 | 3.36 | 17.0-230 |
| 35 | 5 | 5.05 | 2.00-6.90 |
| 36 | 5 | 6.73 | 0.25-1.90 |
| 37 | 5 | 8.41 | 0.31-0.53 |

### Examples 38-41 and Comparative Examples A-D

Polymerizable compositions were prepared by dissolving 2.0 g (6.73 mM) of zinc nitrate hexahydrate in a solution of 5.0 g (38 mM) of HEMA and 2.0 g (22 mM) of MPOH. To the above solution, 4-hydroxy-TEMPO (as a 20 g 4-hydroxy-TEMPO in MPOH, one liter of solution) was added at different concentrations. The polymerizable compositions were heated in an oil bath for up to 30 min at 80° C. The observations made during the reaction and the coating characteristics are reported in Table 3 (below).

TABLE 3

| | 4-HYDROXY- | APPEARANCE OF REACTION |
|---|---|---|
| | TEMPO, | MIXTURE COATING |
| EXAMPLE | mM | CHARACTERISTICS |
| COMPARATIVE | 0 | No reaction upto 48 hrs. |
| EXAMPLE A | | |
| COMPARATIVE | 0.000055 | Slight increase in viscosity, no |
| EXAMPLE B | | change in color. No change up to |
| | | 4 hrs of reaction. Forms a salt layer |
| | | when coated, which could be |
| | | easily removed. |
| COMPARATIVE | 0.000437 | Turns into a light yellow color sol |
| EXAMPLE C | | with a slight increase in viscosity. No |
| | | change up to 4 hrs of reaction. |
| | | Forms a salt layer when coated, |
| | | which could easily be removed. |
| 38 | 0.001091 | Turns into a yellow colored viscous |
| | | sol in 30 min. Forms a clear coating. |
| 39 | 0.001637 | Turns into a yellow colored viscous |
| | | sol in 30 min. Forms a clear coating. |
| 40 | 0.002183 | Turns into a yellow colored viscous |
| | | sol in 30 min. Forms a clear coating. |
| 41 | 0.003274 | Turns into a yellow colored |
| | | viscous sol. Forms a clear coating. |
| COMPARATIVE | 0.005457 | Amber color sol with slight increase |
| EXAMPLE D | | in viscosity up to 12 hrs of reaction. |
| | | Forms a salt layer when coated. |

### Examples 42-47 and Comparative Examples E-H

Surface resistivity values of the coatings obtained with the above compositions at different dry coating thicknesses are given in Table 4. The reaction was carried out by changing the 4-Hydroxy-TEMPO concentration as listed in Table 4 (below), and maintaining the zinc nitrate (6.7 mM), HEMA (38 mM) and MPOH (22 mM) concentrations at constant levels.

TABLE 4

| | DRY | | | SURFACE | |
|---|---|---|---|---|---|
| | COATING | POLYMERIZED | 4-HYDROXY-TEMPO | RESISTIVITY, | |
| | THICKNESS, | COMPOSITION, | CONCENTRATION, | 10⁷ | HAZE, |
| EXAMPLE | microns | EXAMPLE | mM | ohms/square | percent |
| COMPARATIVE | 2 | COMPARATIVE | 0.000054 | 1.1-120 | 10.32 |
| EXAMPLE E | | EXAMPLE B | | | |
| COMPARATIVE | 2 | COMPARATIVE | 0.000436 | 2.5-3100 | 7.42 |
| EXAMPLE F | | EXAMPLE C | | | |
| 42 | 2 | 38 | 0.001091 | 18-430 | 2.51 |
| 43 | 2 | 39 | 0.001637 | 320-440 | 2.41 |
| 44 | 2 | 40 | 0.002182 | 70-490 | 2.57 |
| 45 | 2 | 41 | 0.003274 | 6.1-62 | 2.49 |
| COMPARATIVE | 5 | COMPARATIVE | 0.000054 | 0.38-1.6 | 15.86 |
| EXAMPLE G | | EXAMPLE B | | | |
| COMPARATIVE | 5 | COMPARATIVE | 0.000436 | 1.1-6.1 | 10.36 |
| EXAMPLE H | | EXAMPLE C | | | |
| 46 | 5 | 38 | 0.001091 | 1.7-69 | 2.46 |
| 47 | 5 | 39 | 0.001637 | 7.1-140 | 2.58 |
| 48 | 5 | 40 | 0.002182 | 18-44 | 2.65 |
| 49 | 5 | 41 | 0.003274 | 1.2-180 | 3.08 |

Cross hatch adhesion tests were carried out on coatings obtained with different 4-hydroxy-TEMPO content in the reaction mixture. The coatings were done according to the COATING APPLICATION METHOD (hereinabove). Coatings derived from Comparative Examples B and C (i.e., Comparative Examples E-H) failed the CROSS HATCH ADHESION TEST with about 50 percent peel-off. Coatings derived from Examples 38-41 (i.e., Examples 42-49) showed very good peel adhesion with little or no (0-5 percent) coating peel-off, indicating the formation of an adherent coating on polyester.

### Example 50

In order get the UV curable coating solution, instead diluting with MPOH, polymerized compositions resulting from Examples 3-9 were diluted with HEMA monomer. IRGACURE 184 photoinitiator (0.01 g, Ciba-Geigy Corp, Switzerland) was added into the coating solution. The UV curable coating solution was a mixture of HEMA oligomers present in the reaction mixture and HEMA monomer added to dilute the reaction mixture prior to coating. This polymerizable composition was bar coated at various thicknesses onto polyester film and cured using a UV lamp equipped with a D-type bulb (Fusion UV Systems, Gaithersburg, Md.) with 0.945 W/cm² intensity. The coatings exposed for 3 sec (UV dose of 2835 mJ/cm²) resulted in colorless transparent coatings. Coatings of 2 microns thickness showed surface resistivity in the range of 10⁸-10⁹ ohm/square, and 5 microns thick coatings had surface resistivity in the range of 10⁷-10⁸ ohms/square.

### Examples 51-53

Zinc nitrate hexahydrate, HEMA, methanol, and 4-hydroxy-TEMPO (as a 2 percent by weight solution in methanol) were combined with mixing in a glass vessel in amounts as reported in Table 5. The resultant polymerizable compositions were heated at 100° C., and the reaction progress was monitored at 5 minute intervals. The time for each polymerizable composition to turn into a viscous sol was taken as the time for completion of the reaction. The resultant viscous sols were diluted to 50 percent by weight with methanol with mixing.

TABLE 5

| | ZINC | | | | TIME TO |
|---|---|---|---|---|---|
| | NITRATE | | METH- | 4- | FORM |
| | HEXA- | | A- | HYDROXY- | VISCOUS |
| | HYDRATE, | HEMA, | NOL, | TEMPO, | SOL, |
| EXAMPLE | mM | mM | mM | mM | min |
| 51 | 3.36 | 38 | 40 | 0.00109 | 25 |
| 52 | 3.36 | 38 | 40 | 0.00218 | 40 |
| 53 | 6.73 | 38 | 80 | 0.00218 | 150 |

### Examples 54-65

Viscous sols obtained from Examples 51-53 were diluted to the percent by weight of methanol as reported in Table 6, and coated onto polyester film using Meyer rods, which after drying/curing resulted in dry film thickness as reported in Table 6. The coatings were thermally cured at 100° C. and 120° C. in the oven as reported in Table 6 (below).

TABLE 6

| | | DRY | | | SURFACE | |
|---|---|---|---|---|---|---|
| | SOLVENT | COATING | POLYMERIZED | CURING | RESISTIVITY, | |
| | CONCENTRATION, | THICKNESS, | COMPOSITION | TEMPERATURE | 10⁷ | HAZE, |
| EXAMPLE | percent by weight | microns | EXAMPLE | AND TIME | ohms/square | percent |
| 54 | 50 | 1-2.5 | 51 | 100° C.,17 min | 41-567 | 2 |
| 55 | 50 | 3-5 | 51 | 100° C.,17 min | 17-78 | 3 |
| 56 | 50 | 1.1-2 | 51 | 120° C.-3 min | 120-229 | 2 |
| 57 | 50 | 1.5-3.5 | 51 | 120° C.-3 min | 10.6-190 | 3 |
| 58 | 50 | 1.1-2 | 52 | 120° C.-3 min | 120-229 | 2 |
| 59 | 50 | 1.5-3.5 | 52 | 120° C.-3 min | 106-190 | 3 |
| 60 | 50 | 1.5-2.9 | 53 | 100° C.-15 min | 9.8-2.7 | 3 |
| 61 | 50 | 2.1-4 | 53 | 100° C.-15 min | 0.53-9.2 | 3 |
| 62 | 50 | 1.4-2.7 | 53 | 120° C.-2.5 min | 1.2-69 | 3 |
| 63 | 50 | 1.9-3.8 | 53 | 120° C.-3 min | 0.1-1.9 | 3 |
| 64 | 33 | 1.8-3.2 | 53 | 120° C.-2 min | 2.2-45 | 3 |
| 65 | 33 | 2.5-4.4 | 53 | 120° C.-2.5 min | 0.1-10.2 | 4 |

### Examples 66-69

Zinc nitrate hexahydrate was reacted with HPPA monomer instead of the HEMA monomer in methanol/MPOH mixed solvent (as reported in Table 7) with 4-hydroxy-TEMPO at 100° C. The concentrations of the components used are reported in Table 7 (below)

TABLE 7

| | | | | | TIME TO |
|---|---|---|---|---|---|
| | | | | 4- | FORM |
| | ZINC | | METH- | HYDROXY- | VISCOUS |
| | NITRATE, | HPPA, | ANOL, | TEMPO, | SOL, |
| EXAMPLE | mM | mM | mM | mM | min |
| 66 | 1.68 | 22.5 | 40 | 0.00109 | 70 |
| 67 | 3.36 | 22.5 | 40 | 0.00109 | 40 |
| 68 | 6.73 | 22.5 | 80 | 0.00109 | 25 |
| 69 | 3.36 | 38 | 40 | 0.00109 | 60 |

### Examples 70-72

The viscous sols obtained with the above reaction were diluted with 50 percent by weight of methanol and coated onto PET polyester film using Meyer rods. The coatings were cured at 120° C. and all gave clear cured coatings. Cure times are reported in Table 8 (below).

TABLE 8

| | | | DRY | SURFACE |
|---|---|---|---|---|
| | REACTION | CURING | COATING | RESISTIVITY, |
| | MIXTURE, | TIME, | THICKNESS, | 10⁷ |
| EXAMPLE | EXAMPLE | min | microns | ohms/square |
| 70 | 51 | 3 | 1.5-2.9 | 420-5120 |
| 71 | 52 | 2 | 1-2.5 | 12-2700 |
| 72 | 53 | 2 | 1.1-2 | 3.4-72 |

### Comparative Example I

The effect of different acrylate and methacrylate monomers in place of HEMA was studied by reacting the monomers with Zn(NO₃)₂ in presence of 4-hydroxy-TEMPO in MPOH solvent. The reactions were carried out with the following acrylates/methacrylates without —OH groups: isobornyl acrylate, dipentaerythritol pentaacrylate (SR399 from Sartomer USA, LLC), ethoxylated (4) bisphenol A diacrylate (SR 601B from Sartomer USA, LLC), methyl methacrylate, 2-(N,N-dimethylamino)ethyl acrylate, and ethylene glycol dimethacrylate. Concentrations were: 38 mM of acrylate/methacrylate, 3.36 mM of zinc nitrate hexahydrate, 22 mM of MPOH, and 0.00109 mM of 4-hydroxy-TEMPO. The reactions were carried out for up to 12 hrs at 80° C., and monitored at 30 min intervals. In general, the reactions observed with acrylates/methacrylates without —OH groups is entirely different from that observed with acrylates/methacrylates with —OH groups (HEMA and HPPA). The reactions of monomers without —OH groups resulted in the formation of salt precipitate with separation of the salt layer and the monomer layer Infrared (FTIR) analysis of the salt layer and the monomer layer did not show any polymerization of the methacrylates/acrylates.

All examples given herein are to be considered non-limiting unless otherwise indicated. Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A polymerizable composition comprising:
from 10x to 50x moles of at least one hydroxy-functional (meth)acrylate ester having a hydroxyl group, wherein x is a positive number;
from 0.1x to 25x moles of at least one metal nitrate compound, wherein the at least one metal nitrate compound comprises at least one metal selected from the group consisting of Al, Ti, V, Cr, Mn, Fe, Co, Ni, Cu, Zn, Ga, Ge, Mo, Pd, Ag, Cd, Sn, Sb, Te, Pt, Au, Pb, Bi, and combinations thereof; and
from 0.001x to 0.0035x moles of at least one organic compound having a sterically hindered aminooxyl group.

2. The polymerizable composition of claim 1, wherein the reactive component comprises from 15x to 25x moles of the at least one hydroxy-functional (meth)acrylate ester having a hydroxyl group.

3. The polymerizable composition of claim 1, wherein the at least one hydroxy-functional (meth)acrylate ester having a hydroxyl group comprises a (meth)acrylate ester selected from the group consisting of 2-hydroxyethyl (meth)acrylate, 2-hydroxypropyl (meth)acrylate, 3-hydroxypropyl (meth)acrylate, 4-hydroxybutyl (meth)acrylate, HO(CH₂)₅C(═O)O(CH₂)₅C(═O)OCH₂CH₂C(═O)CH═CH₂, HO(CH₂)₅C(═O)O(CH₂)₅C(═O)OCH₂CH₂C(═O)C(CH₃)═CH₂, (2-hydroxy-1-methylethyl) (meth)acrylate, 2-hydroxy-3-phenoxypropyl (meth)acrylate, (2-hydroxy-1-phenylethyl) (meth)acrylate, and combinations thereof.

4. The polymerizable composition of claim 1, further comprising at least one non-free-radically-polymerizable solvent.

5. The polymerizable composition of claim 1, wherein the at least one hydroxy-functional (meth)acrylate ester having a hydroxyl group comprises 2-hydroxyethyl methacrylate.

6. The polymerizable composition of claim 1, wherein the reactive component comprises from x to 8x moles of the at least one metal nitrate compound.

7. The polymerizable composition of claim 1, wherein the at least one metal nitrate consists essentially of zinc nitrate.

8. The polymerizable composition of claim 1, wherein the at least one organic compound having a sterically hindered aminooxyl group comprises TEMPO or a substituted derivative thereof.

9. The polymerizable composition of claim 1, wherein the at least one organic compound having a sterically hindered aminooxyl group comprises a compound represented by the formula: 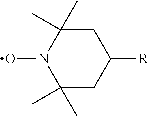
wherein R represents H, amino, acetamido, carboxyl, cyano, benzoyloxy, hydroxyl, phenyl, and alkyl having from 1 to 6 carbon atoms.

10. A polymerized composition made by at least partially polymerizing the at least one hydroxy-functional (meth)acrylate ester having a hydroxyl group in the polymerizable composition of claim 1.

11. An article comprising a substrate, and a layer comprising the polymerized composition of claim 1 disposed on a surface of the substrate.

12. The article of claim 11, wherein the layer has a surface resistivity of less than or equal to 10¹⁰ ohms/square.

13. The article of claim 11, wherein the layer has a surface resistivity of less than or equal to 10⁸ ohms/square.

14. The article of claim 11, wherein the layer is colorless and transparent.

15. A method of making an article, the method comprising:
disposing a layer of the polymerizable composition of claim 1 onto a substrate; and
at least partially polymerizing the at least one hydroxy-functional (meth)acrylate ester having a hydroxyl group.

16. The method of claim 15, further comprising heating the layer to cause polymerization.
